(19) United States
(12) Patent Application Publication
(10) Pub. No.: US 2015/0249306 A1
(43) Pub. Date: Sep. 3, 2015

(54) ELECTRICAL CARD CONNECTOR WITH EJECT MECHANISM

(71) Applicant: FOXCONN INTERCONNECT TECHNOLOGY LIMITED, Grand Cayman (KY)

(72) Inventors: MING-QIU HAN, Kunshan (CN); JIAN-FEI YU, Kunshan (CN); DING-BING FAN, Kunshan (CN); QI-SHENG ZHENG, Kunshan (CN); GUO-HUA ZHANG, Kunshan (CN); JI-CHAO WANG, Kunshan (CN)

(21) Appl. No.: 14/637,244

(22) Filed: Mar. 3, 2015

(30) Foreign Application Priority Data
Mar. 3, 2014 (CN) 201420092524.3

(51) Int. Cl. H01R 13/635; H01R 12/73

(52) U.S. Cl. CPC H01R 13/635; H01R 12/73

(57) ABSTRACT

An electrical card connector adapted for receiving an electrical card, comprises an insulative housing, a plurality of contacts received in the insulative housing, and a shell covering the insulative housing. The shell includes an upper shell with a top wall and a lower shell, the upper shell and the insulative housing define a space for the electrical card. The electrical card connector further has an eject mechanism mounted on the top wall. The eject mechanism has an eject member and a push member, the eject member has a fixing arm, the push member has a mounting wall fixed with the fixing arm to fix the push member to the eject member. Such arrangement can reduce the difficulty of molding process and the manufacturing costs of the electrical card connector.

### BACKGROUND OF THE INVENTION

1. Field of the Invention

The present invention relates to an electrical card connector, and more particularly to an electrical card connector with an eject mechanism.

2. Description of Prior Arts

CN102651505A, published on Aug. 29, 2012, discloses an electrical card connector. The electrical card connector includes an insulative housing, a plurality of contacts received in the insulative housing, a shell covering the insulative housing, and an eject mechanism disposed on the shell. The eject mechanism includes an eject member and a push member bent from an end of the eject member, the eject member and the push member are stamped, punched and bent by a metal sheet by one time. Although this design reduces the process steps, it is difficult to make it. This leads a low good rate and a high manufacturing cost, and it is not convenient to have a mass production.

An electrical card connector with an improved eject mechanism is desired.

### SUMMARY OF THE INVENTION

An electrical card connector having a space for receiving an electrical card comprises an insulative housing, a plurality of contacts received in the insulative housing, and a shell covering the insulative housing. The shell includes an upper shell and a lower shell, the upper shell and the insulative housing define the space, the upper shell having a top wall. The electrical card connector also have an eject mechanism mounted on the top wall. The eject mechanism has an eject member and a push member assembled to one end of the eject member, the eject member has a fixing arm, the push member has a mounting wall fixed with the fixing arm to make the push member fixed in the eject member.

Other advantages and novel features of the invention will become more apparent from the following detailed description of the present embodiment when taken in conjunction with the accompanying drawings.

### BRIEF DESCRIPTION OF THE DRAWING

FIG. 1 is an assembled, perspective view of an electrical card connector in accordance with the present invention;

FIG. 2 is another perspective view of the electrical card connector as shown in FIG. 1;

FIG. 3 is a partially, exploded view of the electrical card connector as shown in FIG. 2;

FIG. 4 is a further exploded view of the electrical card connector without a tray as shown in FIG. 3;

FIG. 5 is an another perspective view of the electrical card connector as shown in FIG. 4;

### DETAILED DESCRIPTION OF THE PREFERRED EMBODIMENT

Reference will now be made to the drawing figures to describe the present invention in detail.

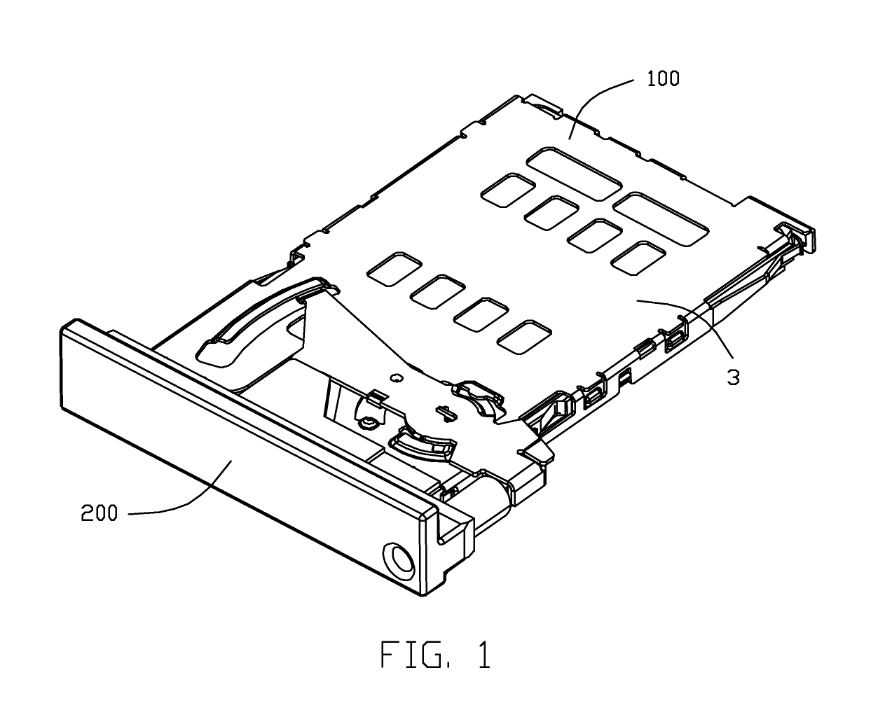

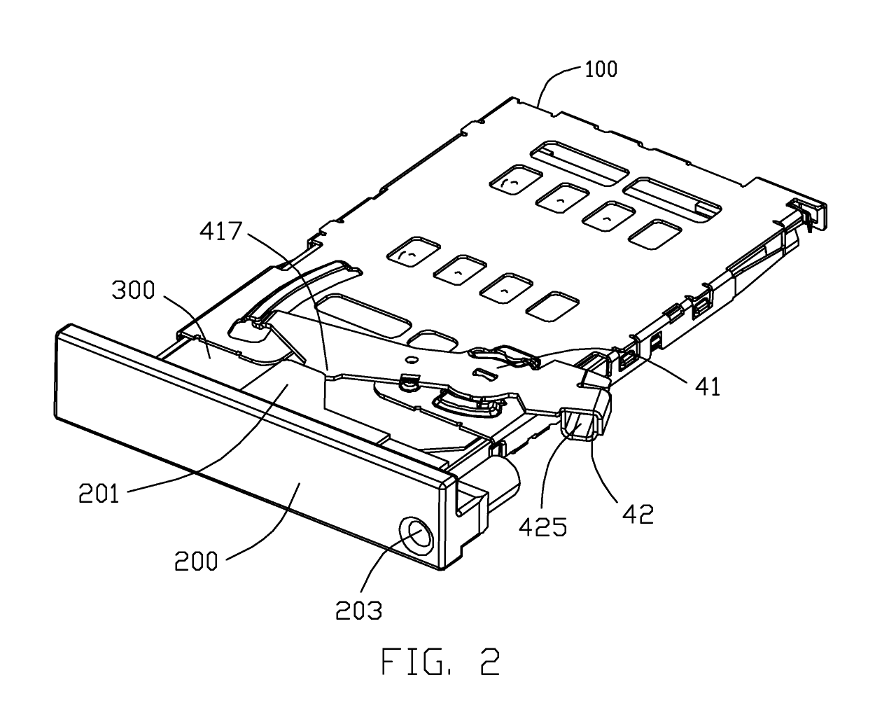

FIGS. 1-3 show an electrical card connector 100 mounted onto a printed circuit board used for receiving an electrical card 300. The electrical card connector 100 includes an insulative housing 1, a tray 200 movably mounted in the insulative housing 1, a plurality of contacts 2 received in the insulative housing 1, a shell 3 covering the insulative housing 1, an eject mechanism 4 mounted on the shell 3, and a switch contact 5 received in a rear portion of the insulative housing 1. The insulative housing 1 and the shell 3 define a space 101 for receiving the tray 200. Refer to FIG. 1, when the tray 200 is received in the space 101 completely, the eject mechanism 4 is in a receiving position. Refer to FIG. 2, when the tray 200 is ejected out of the space 101, the eject mechanism 4 is in an ejecting position.

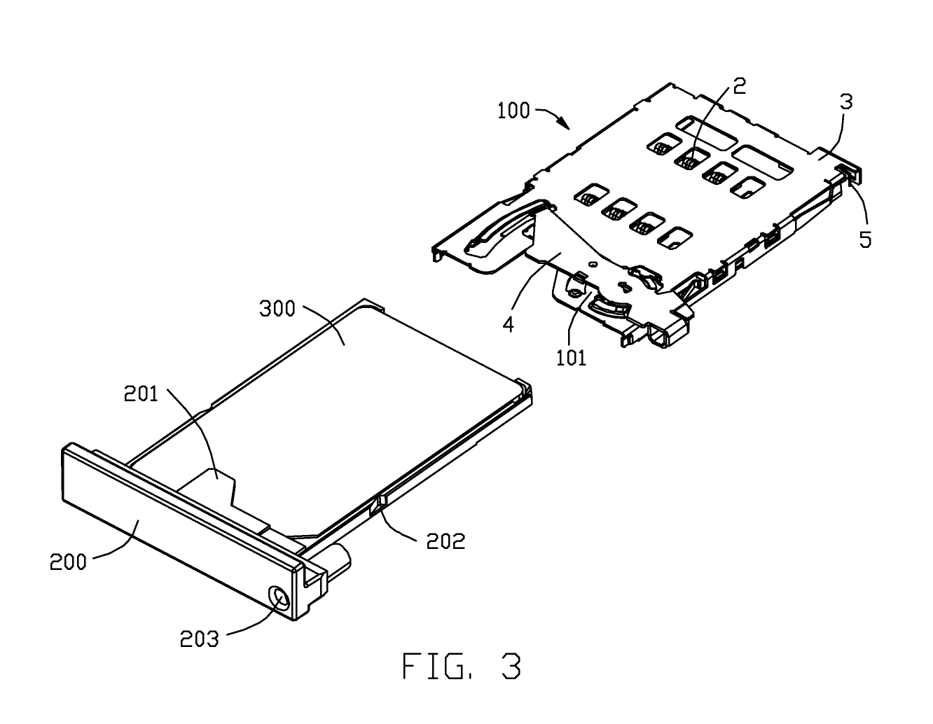

FIGS. 2-3 show the tray 200 including a first portion and a second portion extending from the first portion backwardly and used for supporting the electrical card 300. The tray 200 also includes a push portion 201 extending from the first portion backwardly and located above the second portion. The eject mechanism 4 pushes the push portion 201 outwardly and ejects the tray 200 out of the space 101. The tray 200 includes two recesses 202 defined at two sides of the second portion respectively. The tray 200 includes a hole 203 extending through the first portion along a front-to-back direction and used for being inserted by a pin.

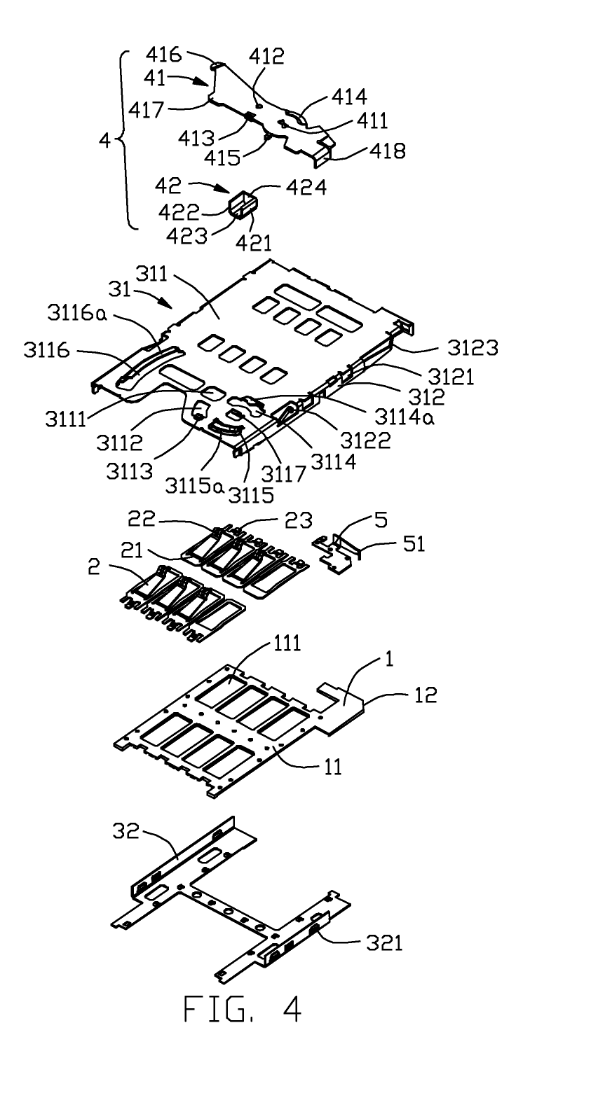

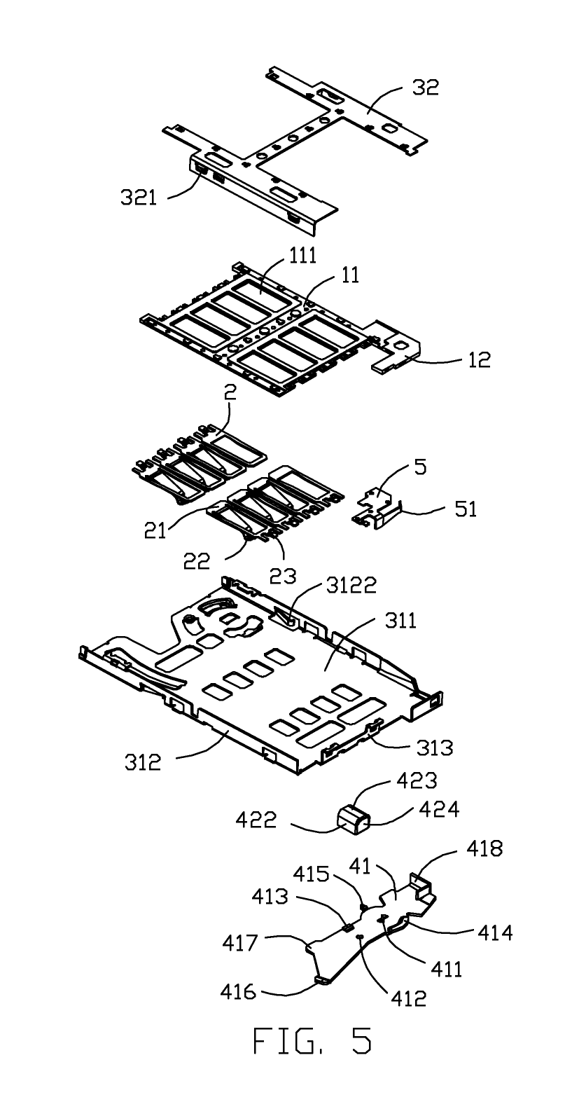

FIGS. 4-5 show the insulative housing 1 including a rectangular main body 11 and an projection 12 bent from an end of the main body 11. The insulative housing 1 has a plurality of openings 111 extending through the main body 1 along an upper-to-down direction.

The contacts 2 are embedded received in the insulative housing 1 and each includes a fixing portion 21 received in the main body 11, a contacting portion 22 extending from one end of the fixing portion 11 upwardly and through the opening 111 to the space 101, and a soldering portion 23 extending from the other end of the fixing portion 21 outwardly and beyond the insulative housing 1. The contacting portion 22 is an elastic portion. The switch contact 5 is integrated in the projection 12. The switch contact 5 is embedded in the insulative housing 1 and includes a contacting arm 51 extending to the space 101.

The shell 3 includes an upper shell 31 covering an upper face of the insulative housing 1 and a lower shell 32 covering a lower face of the insulative housing 1. The upper shell 31 includes a top wall 311, two side walls 312 bent from two sides of the top wall 311 downwardly, and a rear wall 313 bent from a rear end of the top wall 311 downwardly, the rear wall 313 is used for blocking the tray 200. The top wall 311 includes a first receiving hole 3111 and a second receiving hole 3112, the first receiving hole 3111 and the second receiving hole 3112 extend through the top wall 311 along the upper-to-down direction and are arranged one by one along an inserting direction of the electrical card 300. The top wall 311 includes a resisting portion 3113 protruding from the second receiving hole 3112 upwardly. The upper shell 31 includes a first connecting hole 3114, a second connecting hole 3115 and a third connecting hole 3116 extending through the top wall 311 along the upper-to-down direction. The first connecting hole 3114 and the second connecting hole 3115 are located at the right side of the top wall 311 and arranged one by one along the inserting direction of the electrical card 300, the third connecting hole 3116 is located at the left side of the top wall 311. The two side walls 312 also have a plurality of holding holes 3121. Each of the two side walls 312 includes an elastic holding arm 3122 extending towards the space 101, the elastic holding arm 3122 is used for holding against the recess 202 of the tray 200. A right side wall of the two side walls 312 also includes a switch arm 3123, the switch arm 3123 is cooperated with the contacting arm 51 of the switch contact 5 to detect an inserting state of the electrical card 300.

The upper shell 31 includes a rotating member 3117 tearing from the top wall 311 upwardly, the rotating member 3117 is located between the first connecting hole 3114 and the second connecting hole 3115, the rotating member 3117 protrudes from the top wall 311 upwardly as a rectangle shape.

The upper shell 31 includes a first protective portion 3114a, a second protective portion 3115a and a third protective portion 3116a protruding from the top wall 311 upwardly. The first protective portion 3114a, the second protective portion 3115a and the third protective portion 3116a partially cover the first connecting hole 3114, the second connecting hole 3115 and the third connecting hole 3116, respectively.

The lower shell 32 includes two tubers 321 engaging with the holding holes 3121 of the two side walls 312 of the upper shell 31, respectively. The lower shell 32 engages with the upper shell 31 by the tubers 321 and the holding holes 3121.

The eject mechanism 4 includes an eject member 41 and a push member 42 assembled to the eject member 41. The eject member 41 is stamped, punched and bent by a metal sheet by one time, and the push member 42 is formed by turning. The eject member 41 includes a shaft hole 411 as a dumbbell shape. The rotating member 3117 of the upper shell 31 is inserted into the shaft hole 411 to support the eject mechanism 4. The eject mechanism 4 rotates around the rotating member 3117 within a certain range, the certain range is defined between the receiving position and the ejecting position.

The eject member 41 includes an emboss 412 protruding from a lower face of the eject member 41 downwardly and a stop portion 413 located in front of the emboss 412. When the eject mechanism 4 is located in the receiving position, the emboss 412 is received in the first receiving hole 3111. When the eject mechanism 4 is located in the ejecting position, the emboss 412 is received in the second receiving hole 3112 and the stop portion 413 holds against the resisting portion 3113 of the shell 3, this avoid the eject mechanism 4 rotating continually.

The eject member 41 includes a main portion, a first connecting portion 414, a second connecting portion 415 and a third connecting portion 416. The first connecting portion 414, the second connecting portion 415 and the third connecting portion 416 are all bent from the main portion downwardly. The first connecting portion 414 and the second connecting portion 415 are located at two sides of the shaft hole 411 along a first-to-back direction, the third connecting portion 416 is located at an extending end of the eject member 41 being far from the shaft hole 411. The first connecting portion 414, the second connecting portion 415 and the third connecting portion 416 are received in the first connecting hole 3114, the second connecting hole 3115 and the third connecting hole 3116, respectively. The first protective portion 3114a, the second protective portion 3115a and the third protective portion 3116a are corresponding to the first connecting portion 414, the second connecting portion 415 and the third connecting portion 416 respectively to prevent the eject mechanism 4 from moving from the shell 3. The first protective portion 3114a, the second protective portion 3115a and the third protective portion 3116a are located above the first connecting portion 414, the second connecting portion 415 and the third connecting portion 416, respectively. When the eject mechanism 4 rotates around the rotating shaft 3117, the first protective portion 3114a, the second protective portion 3115a and the third protective portion 3116a prevent the eject mechanism 4 from leaving from the upper shell 31.

When the eject mechanism 4 is in the receiving position, the emboss 412 is received in the first receiving hole 3111. When the eject mechanism 4 is in the ejecting position, the emboss 412 is received in the second receiving hole 3112. When the eject mechanism 4 is located between the receiving position and the ejecting position, the emboss 412 is located above a portion between the first receiving hole 3111 and the second receiving hole 3112, and the eject member 41 of the eject mechanism 4 holds against the first protective portion 3114a, the second protective portion 3115a and the third protective portion 3116a, and this makes the emboss 412 engage with the shell 3 closely. When the emboss 412 enters into the receiving position or the ejecting position, the eject member 41 and the upper shell 31 will have a feeling.

The eject member 41 also includes an eject portion 417 extending from a front edge of the eject member 41 forwardly. When the eject mechanism 4 moves from the receiving position to the ejecting position, the eject portion 417 will provide a force to the push portion 201 of the tray 200, and makes the tray 200 leave from the space 101.

The push member 42 is formed by turning a metal sheet. The eject member 41 has a fixing arm 418 bent downwardly at an extending end, the push member 42 is fixed in the fixing arm 418 by a welding way. The push member 42 includes a mounting wall 421 fixed to the fixing arm 418, a fixing wall 422 facing to the mounting wall 421, a bottom wall 423 connecting the mounting wall 421 with the fixing wall 422, and a holding wall 424 located at a rear of the push member 42. A pressing space 425 used for receiving a pin is formed by the mounting wall 421, the fixing wall 422, the holding wall 424, the bottom wall 423 and the eject member 41, and under the main body of the eject member 41. Notably, the mounting wall 421, the fixing wall 422, the holding wall 424, the bottom wall 423 and the corresponding portion of the main body of the eject member 41 commonly forms a pocket structure to enclose the pressing space 425 which is essentially located behind the hole 203. Understandably, such a pocket structure may restrict an inserted ejecting pin circumferentially and stop such an inserted ejecting pin to have such an inserted ejecting pin properly actuate the ejecting member 41 to pivotally move with regard to the

In other embodiment, the push member 42 can present a “V” shape or a spoon shape. The push member 42 of the “V” shape is without the holding wall 424 but includes a pressing space 425 formed only by the mounting wall 421, the fixing wall 422, the bottom wall 423 and the eject member 41, the mounting wall 421 and the fixing wall 422 intersect to form a “V” shape. The push member 42 of a spoon shape includes a holding wall 423 presenting as a circular arc shape, the holding wall 423 connects to the mounting wall 421 and the fixing wall 422 smoothly. The push member 42 can be fixed to the eject member 41 by some other fixing ways.

The eject mechanism 4 of the present invention includes an eject member 41 and a push member 42 formed by separately molding processes, and the eject member 41 and the push member 42 are fixed together by a welding way or some other fixing ways. This reduces the difficulty of the molding process and lowers the manufacturing cost of the electrical card connector. This also improves a good rate of the electrical card connectors and increases a production of the electrical card connectors.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical card connector comprising:
an insulative housing;
a plurality of contacts received in the insulative housing;
an upper shell covering the insulative housing, the upper shell and the insulative housing cooperatively defining a space, the upper shell having a top wall; and an eject mechanism mounted on the top wall, the eject mechanism having an eject member and a push member assembled to one end of the eject member, the eject member having a fixing arm, the push member having a mounting wall fixed to the fixing arm to fix the push member to the eject member.

2. The electrical card connector as claimed in claim 1, wherein the fixing arm is bent from the eject member downwardly and overlaps with the mounting wall.

3. The electrical card connector as claimed in claim 1, wherein the push member has a fixing wall facing to the mounting wall, a bottom wall connecting the mounting wall with the fixing wall, and a holding wall located at a rear of the push member, a pressing space is formed by the holding wall, the fixing wall, the mounting wall, the bottom wall and the eject member.

4. The electrical card connector as claimed in claim 3, wherein the eject member is stamped, punched and bent by a metal sheet by one time.

5. The electrical card connector as claimed in claim 4, wherein the eject member has a shaft hole as a dumbbell shape, the upper shell has a rotating member extending through the shaft hole, the eject member is mounted to the upper shell and rotates around the rotating member.

6. The electrical card connector as claimed in claim 5, wherein the eject member has an emboss and a resisting portion located in front of the emboss, the upper shell has a top wall, the top wall has a first receiving hole and a second receiving hole used for receiving the emboss, the second receiving hole is located in front of the first receiving hole.

7. The electrical card connector as claimed in claim 5, wherein the upper shell has two side walls and a rear wall bent from the top wall downwardly, the electrical card connector also comprises a lower shell, each of the two side walls has a holding arm extending into the space and used for holding an electrical card inserted into the space.

8. The electrical card connector as claimed in claim 7, wherein the electrical card connector also has a switch contact received in the insulative housing, a right side wall of the two side walls has a switch arm protruding into the space, the switch contact and the switch arm are used for detecting an inserting state of the electrical card.

9. The electrical card connector as claimed in claim 1, wherein the push member is formed by turning a metal material.

10. The electrical card connector as claimed in claim 1, wherein the push member can present as a “V” shape or a spoon shape.

11. An electrical card connector, adapted for receiving an electrical card, comprising:
an insulative housing;
a plurality of contacts received in the insulative housing;
an upper shell covering the insulative housing, the upper shell and the insulative housing defining a space for receiving the electrical card, the upper shell having a top wall; and an eject mechanism, the eject mechanism having an eject member mounted on the top wall of the upper shell and a push member assembled to one end of the eject member, the eject member having a fixing arm bent from the eject member downwardly, the push member having a mounting wall fixed with the fixing arm to make the push member be fixed to the eject member.

12. The electrical card connector as claimed in claim 11, wherein the push member has a fixing wall facing to the mounting wall, a bottom wall connecting the mounting wall with the fixing wall, and a holding wall located at a rear of the push member, a pressing space is formed by the holding wall, the fixing wall, the mounting wall, the bottom wall and the eject member.

13. The electrical card connector as claimed in claim 12, wherein the eject member is stamped, punched and bent by a metal sheet by one time.

14. The electrical card connector as claimed in claim 13, wherein the eject member has a shaft hole as a dumbbell shape, the upper shell has a rotating member extending through the shaft hole, the eject member is mounted to the upper shell and rotates around the rotating member.

15. The electrical card connector as claimed in claim 14, wherein the eject member has an emboss and a resisting portion located in front of the emboss, the upper shell has a top wall, the top wall has a first receiving hole and a second receiving hole used for receiving the emboss, the second receiving hole is located in front of the first receiving hole.

16. An electrical card connector comprising:
an insulative housing defining a card assembly receiving space forwardly communicating with an exterior in a front-to-back direction;
a card assembly received within said card assembly receiving space and moveable in said front-to-back direction;
a plurality of contacts disposed in the housing with contacting sections extending into the card assembly receiving space in a vertical direction perpendicular to said front-to-back direction; and
an ejecting mechanism having an ejecting member and a pushing member, said ejecting member pivotally moveable about a vertical axis along said vertical direction, and including one end by one side of said vertical axis to abut against the card assembly for ejecting the card assembly, and another end by the other side of said vertical axis; wherein
the pushing member is discrete from but attached to the ejecting member and forms essentially a pocket structure with therein a pressing space to forwardly communicate with the exterior in the front-to-back direction so as to properly restrict/stop an inserted ejecting pin circumferentially and rearwardly, which is rearwardly inserted into the pressing space from a front opening of said pocket structure.

17. The electrical card connector as claimed in claim 16, wherein said pushing member includes a bottom wall, opposite mounting wall and fixing wall, and a rear holding wall.

18. The electrical card connector as claimed in claim 16, further including a metallic shell attached to the housing to shielding the card assembly receiving space in the vertical direction, and said ejecting member is secured to metallic shell.

19. The electrical card connector as claimed in claim 16, wherein said pushing member is soldered to said ejecting member.

20. The electrical card connector as claimed in claim 16, wherein one circumferential side of said pocket structure is shielded by the ejecting member.
